(19) United States
(12) Patent Application Publication
(10) Pub. No.: US 2022/0332598 A1
(43) Pub. Date: Oct. 20, 2022

(54) TURBINE EXHAUST GAS SYSTEM USING PRODUCED WATER AND OZONE INJECTION

(71) Applicant: MARK PATTON, CONROE, TX (US)

(72) Inventor: MARK PATTON, CONROE, TX (US)

(21) Appl. No.: 17/533,840

(22) Filed: Nov. 23, 2021

Related U.S. Application Data
(60) Provisional application No. 63/116,963, filed on Nov. 23, 2020.

(51) Int. Cl. C02F 1/16; C02F 1/04; C02F 1/12; B01D 53/14; B01D 53/18; B01D 53/76

(52) U.S. Cl. CPC C02F 1/16; C02F 1/043; C02F 1/048; C02F 1/12; B01D 53/1493; B01D 53/185; B01D 53/1456; B01D 53/76; C02F 2103/10

(57) ABSTRACT

A system and apparatus for treating and disposing of produced water in conjunction with gas turbine exhaust gas, thereby avoiding problems associated with injecting produced water back into subsurface strata. The system is installed at or near the wellhead where produced water being treated is at a higher temperatures. Produced water is treated with ozone injection in a scrubber with heat applied through introduction of gas turbine exhaust gas. A wet scrubber unit with scrubber packing is used to clean emissions. A produced water pump is used to circulate produced water, and pump produced water through spray nozzles in the scrubber unit for use as the wet scrubbing agent. As produced water evaporates, evaporated salts and solids are continuously removed from the evaporator/scrubber unit by appropriate means, such as an auger system. The evaporated salts and solids are then treated via chemical stabilization in a mixing system with chemical reagents to prevent the residual form from being hazardous. The residual material is then stored and disposed of properly.

The application claims benefit of and priority to U.S. Provisional Application No. 63/116,963, filed Nov. 23, 2020, by Mark Patton, which is incorporated herein by specific reference in its entirety for all purposes. The specifications, drawings, and complete disclosures of U.S. Provisional Application Nos. 62/397,833 and 62/784,525 and 63/116,963, and U.S. patent application Ser. Nos. 15/711,896 and 16/653,864 and 17/517,164 are incorporated herein in their entireties by specific reference for all purposes.

### FIELD OF INVENTION

This invention relates to a system and apparatus for treating produced water from oilfield operations using turbine exhaust gas.

### SUMMARY OF INVENTION

In various exemplary embodiments, the present invention comprises a system and apparatus for treating produced water from oilfield operations using turbine exhaust gas. The system provides an alternative treatment and disposal technique for produced water, thereby avoiding problems associated with injecting produced water back into subsurface strata, such as induced seismicity. The system is configured to be installed at or near the wellhead, thereby avoiding the problems of prior art centralized systems for handling produced water, which are substantially larger and built at a central location to store and gather large quantities of produced water. Centralized systems require the produced water to travel much greater distances and become cooler before treatment, thereby requiring more energy for heating or treatment. In several embodiments, the present invention uses produced water that is at a temperature of greater than 100 degrees F., thereby reducing the amount of energy required for heating.

In one exemplary embodiment, produced water is treated in a scrubber. Heat is applied by turbine exhaust gas and/or through a flare gas field burner, which uses field gas from the oilfield operations (and thus provides a useful alternative to simply open flaring the field gas as a means of preventing the accumulation of field gas for safety reasons as well as preventing the venting of methane, a greenhouse gas, into the atmosphere). A wet scrubber unit with scrubber packing is used to clean emissions (e.g., nitrous oxides, sulfur oxides, acid gases, particulate matter, and the like). A produced water pump is used to circulate produced water, and pump produced water through spray nozzles in the scrubber unit for use as the wet scrubbing agent. The present invention thus optimizes contact and mixing between the hot air and water.

The above process also results in gradual evaporation of the produced water, which results in the accumulation of salts and other solids from the produced water. Evaporated salts and solids are continuously removed from the evaporator/scrubber unit by appropriate means, such as an auger system. The evaporated salts and solids are then treated via chemical stabilization in a mixing system with chemical reagents to prevent the residual form from being hazardous. The residual material is then stored and disposed of properly.

The present invention thus provides a more environmentally-friendly and efficient means of addressing several pollution and related concerns. First, the system eliminates open flaring by using turbine exhaust gas and/or the field gas in a field gas flare burner to heat produced water, and scrubbing the emissions using the heated produced water in a scrubbing unit. Second, the system eliminates or reduces the volume of produced water. And third, the system operates at or near the wellhead, thereby allowing use of the field gas while treating the produced water with less energy required.

### BRIEF DESCRIPTION OF THE DRAWINGS

FIG. 1 shows a view of a system in accordance with an embodiment of the present invention.

FIG. 2 shows another view of a system in accordance with another exemplary embodiment of the present invention.

FIGS. 3-10 shows various views of alternative embodiments of the present invention.

### DETAILED DESCRIPTION OF EXEMPLARY EMBODIMENTS

In various exemplary embodiments, the present invention comprises a system and apparatus for flaring gas from oilfield operations using produced water. The system provides an alternative treatment and disposal technique for produced water, thereby avoiding problems associated with injecting produced water back into subsurface strata, such as induced seismicity.

The improved system of the present invention also is configured to be installed at or near (i.e., close proximity to) the wellhead, thereby avoiding the problems of prior art centralized systems for handling produced water, which are substantially larger and built at a central location to store and gather large quantities of produced water. Centralized systems, however, require the produced water to travel much greater distances and become cooler before treatment, thereby requiring more energy for heating or treatment. The present invention uses produced water that is at a temperature of greater than 100 degrees F., thereby reducing the amount of energy required for heating.

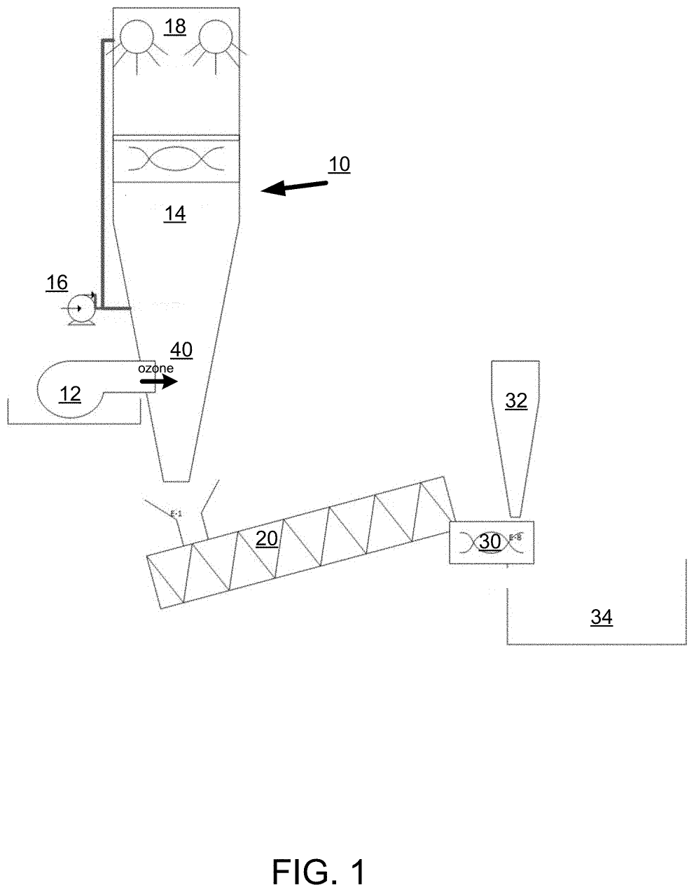

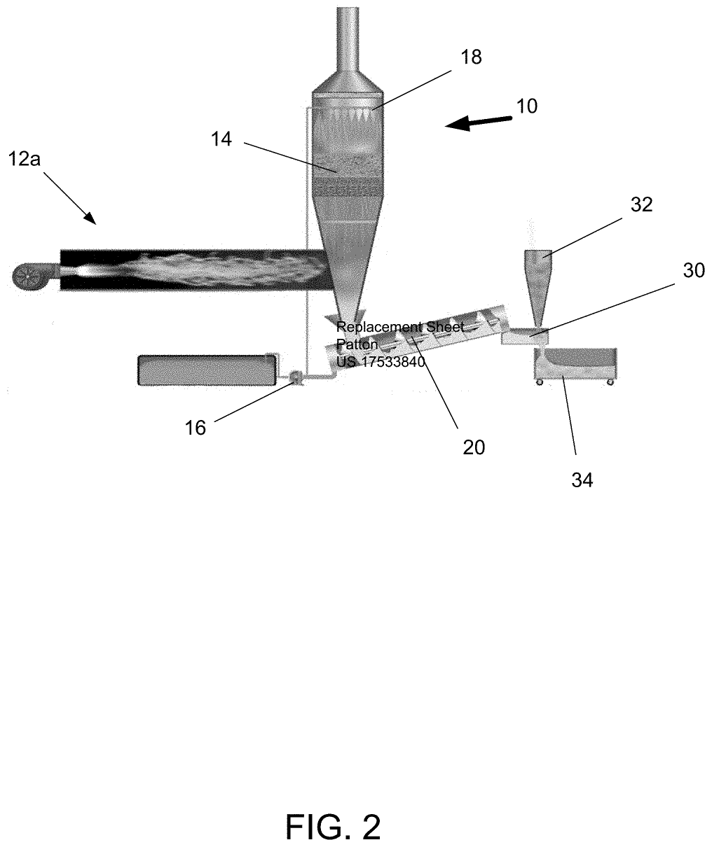

FIGS. 1 and 2 show an exemplary embodiment of an improved system in accordance with the present invention. Produced water is treated in the scrubber unit 10. Heat is applied through a flare gas field burner 12, which uses field gas from the oilfield operations (and thus provides a useful alternative to simply open flaring the field gas as a means of preventing the accumulation of field gas for safety reasons as well as preventing the venting of methane, a greenhouse gas, into the atmosphere). Flare gas may be combusted in an enclosed combustor 12a, with emissions from the combustor passing to to the scrubber unit 10.

A wet scrubber unit with scrubber packing 14 is used to clean emissions (e.g., nitrous oxides, sulfur oxides, acid gases, particulate matter, and the like). A produced water pump 16 is used to circulate produced water, and pump produced water through spray nozzles 18 in the scrubber unit for use as the wet scrubbing agent. The present invention thus optimizes contact and mixing between the hot air and water.

In a further embodiment, ozone is introduced, injected and/or otherwise used in the wet scrubber 10 to reduce NOx by approximately 90% or more. The ozone oxidizes insoluble NOx to a water soluble species form for removal by the scrubber with little or no SO2 or CO oxidation. In several exemplary embodiments, the oxidation of NOx takes place at or below 300 degrees F. (i.e., low temperature oxidation). Ozone may be generated on-site and injected into the evaporator/scrubber unit. In several embodiments, the ozone 40 is added to the effluent gas of the thermal oxidizer/combustor 12a prior to entering the evaporation chamber. As a result, NOx emissions are reduced.

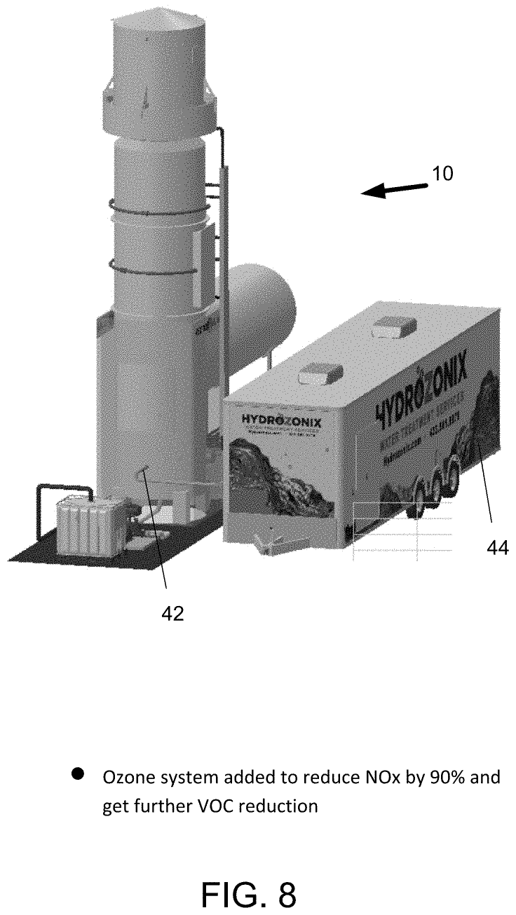

FIG. 8 shows an example of a separate container or wheeled trainer/container 44, which contains one or more ozone-generators and provides ozone through ozone piping for injection 42 into the scrubber 10.

The above process also results in gradual evaporation of the produced water, which results in the accumulation of salts and other solids from the produced water. Evaporated salts and solids are continuously removed from the evaporator/scrubber unit by appropriate means, such as an auger system 20. The evaporated salts and solids are then treated via chemical stabilization in a mixing system (e.g., treatment mixer) 30 with chemical reagents (which are stored in a reagent silo 32) to chemically stabilize the residual and prevent the residual from being hazardous. The residual material is then removed (such as by a roll-off container 34), and stored and disposed of properly.

In several embodiments, increasing the produced water flow rate will create a pumpable slurry that can be used for drilling brine and kill fluids in production operations.

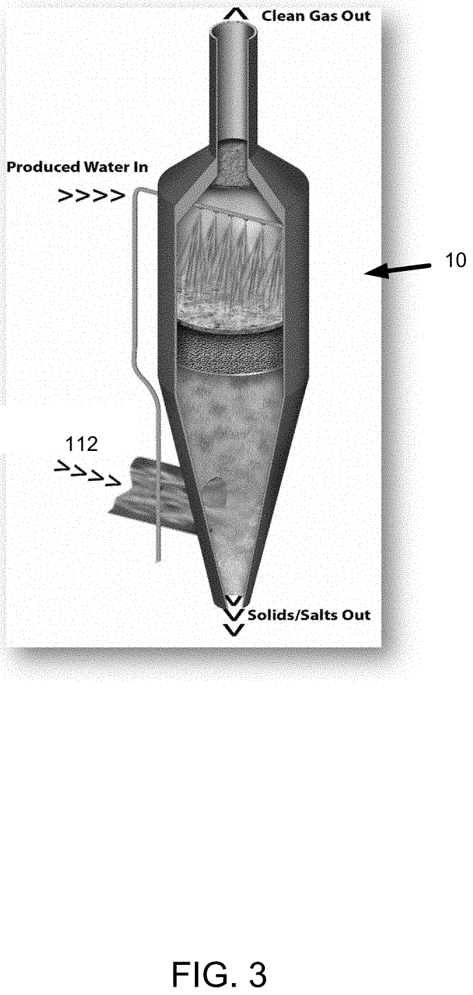

Other sources of heat may be used in place of or along with the flare gas combustion. For example, FIGS. 3-9 show an alternative embodiment of the present invention, where exhaust from a gas turbine 112 in used in the produced water evaporator/scrubber unit described above. The hot gas turbine exhaust replaces or is used in conjunction with the combustion unit for flare gas. The scrubber unit reduces acidic gases (e.g., SOx), volatile metals, and particular matter. Ozone may be introduced, as described above, to reduce NOx (by approximately 90%) and VOCs (see FIG. 8). Salts and solids remaining after evaporation may be removed, treated and disposed of as discussed above.

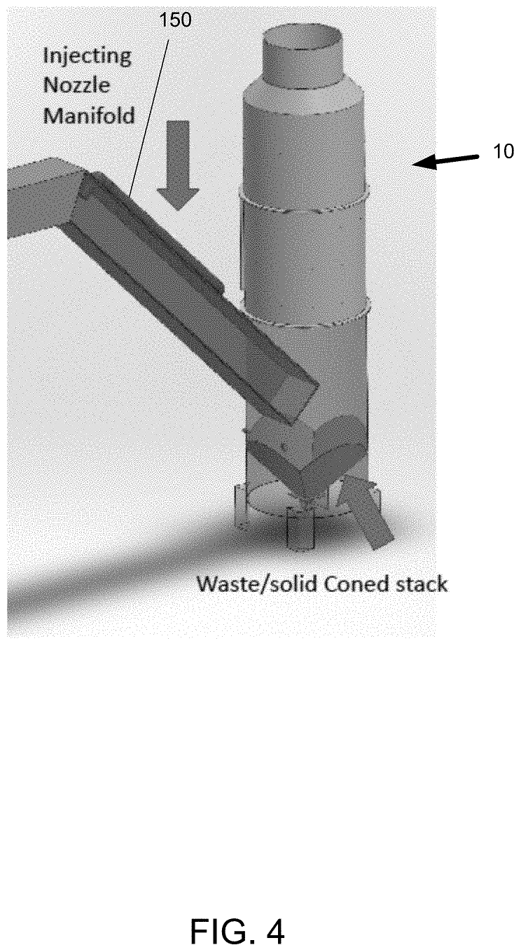

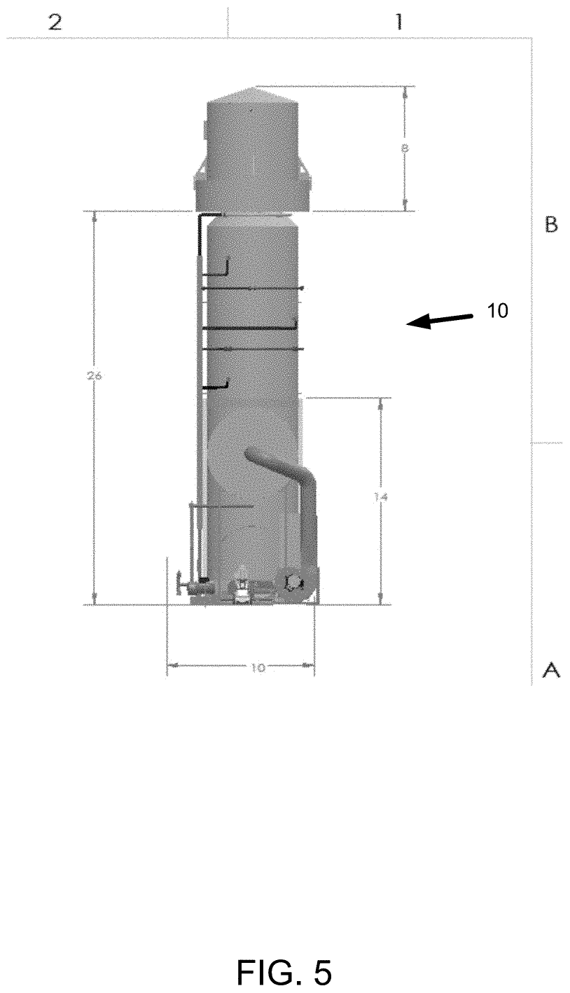

FIG. 4 shows how captured turbine exhaust may be directed to the scrubber unit through ductwork. The ductwork proximate the scrubber unit may have an injecting nozzle manifold 150 for introduction of produced water. FIG. 5 shows a view of the scrubber unit without a separate enclosed combustor, which is not needed because the turbine exhaust gas is heated by the combustion taking place in the gas turbine (this reduces the footprint of the system, allowing the system to be used in smaller spaces). An exhaust fan is used in conjunction with the ductwork to balance the exhaust flow and eliminate any back pressure on the turbine or other flow disruption.

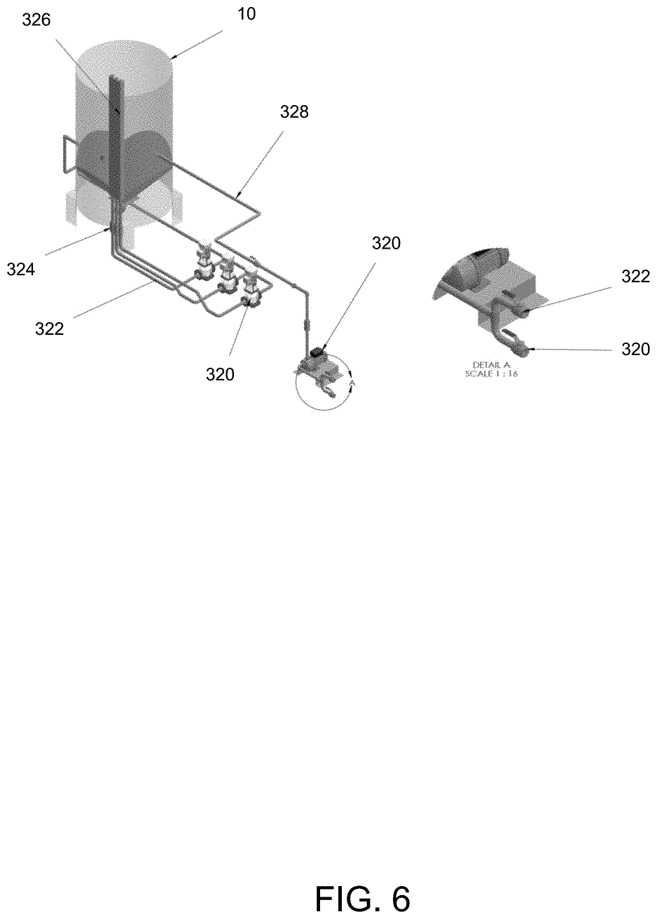

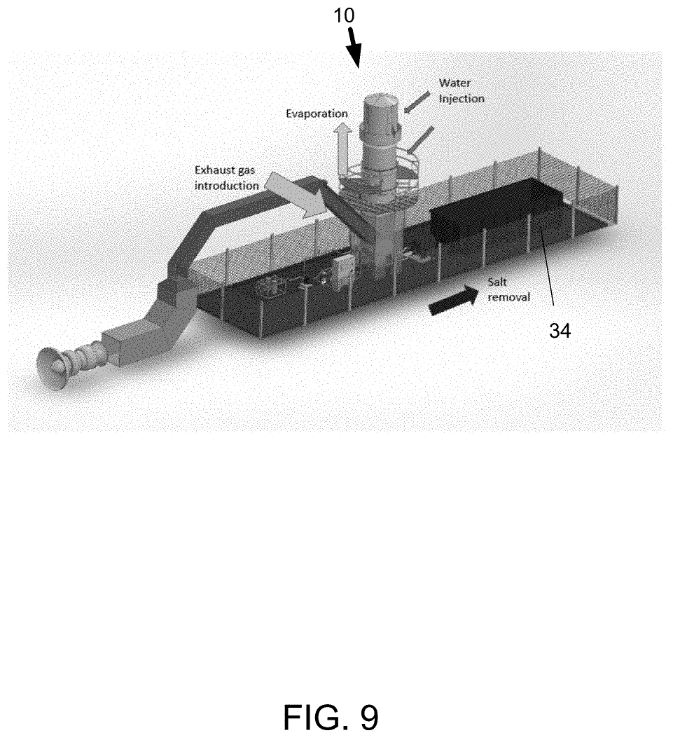

FIG. 6 shows another view of the bottom section (i.e., lower stack) 10b of the scrubber unit with associated water pumps and piping. Water supply pump 320 receives both produced water 322 and fresh water 324 through associated supply connections, which is then sent via water supply line 328 to the scrubbing unit 10 as described above. Water recovered from the scrubbing unit (at or near the bottom) is pumped by one or more water recirculation pumps 330 through water recirculation lines 322 (with flow meters 324) to water lines 326 for the spray nozzles in the top section (upper stack) of the scrubber. In the configuration without a separate combustor, the water lines and pumps fit within the smaller footprint, and ductwork for transmission of the gas turbine exhaust to the scrubber unit passes over the water lines and pumps, thereby allowing connection to the gas turbine without increasing the footprint of the system (see FIG. 9).

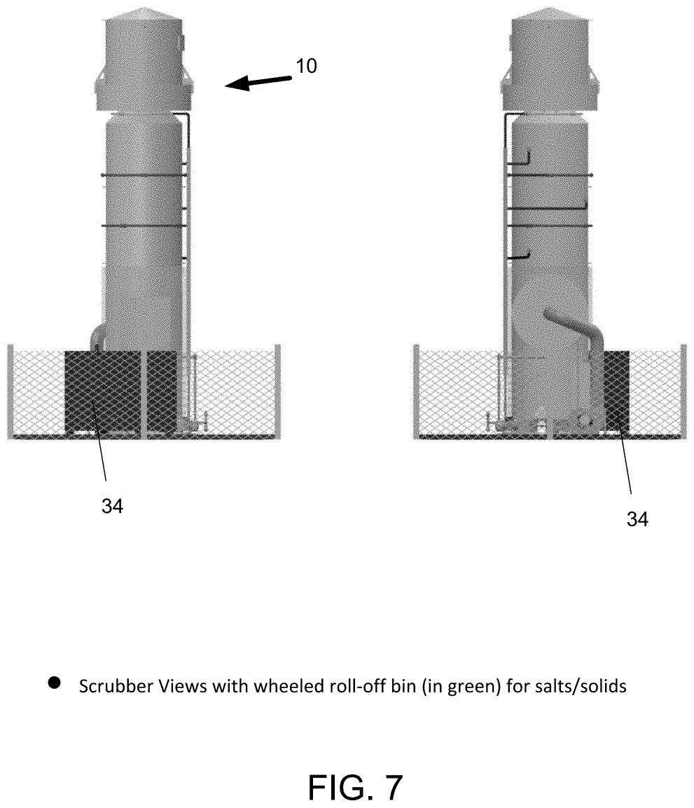

FIGS. 7 and 9 show an embodiment of the present invention with a salt/solids collection or roll-off bin 34. The bin may have wheels, as shown, and can easily be rolled away and replaced as needed.

FIG. 9 shows an enclosed (i.e., fenced) turbine exhaust treatment unit in accordance with the present invention. The distance between the gas turbine (not shown, but connected to the exhaust ductwork from the left side of the figure) and the unit can be shortened or lengthened as needed.

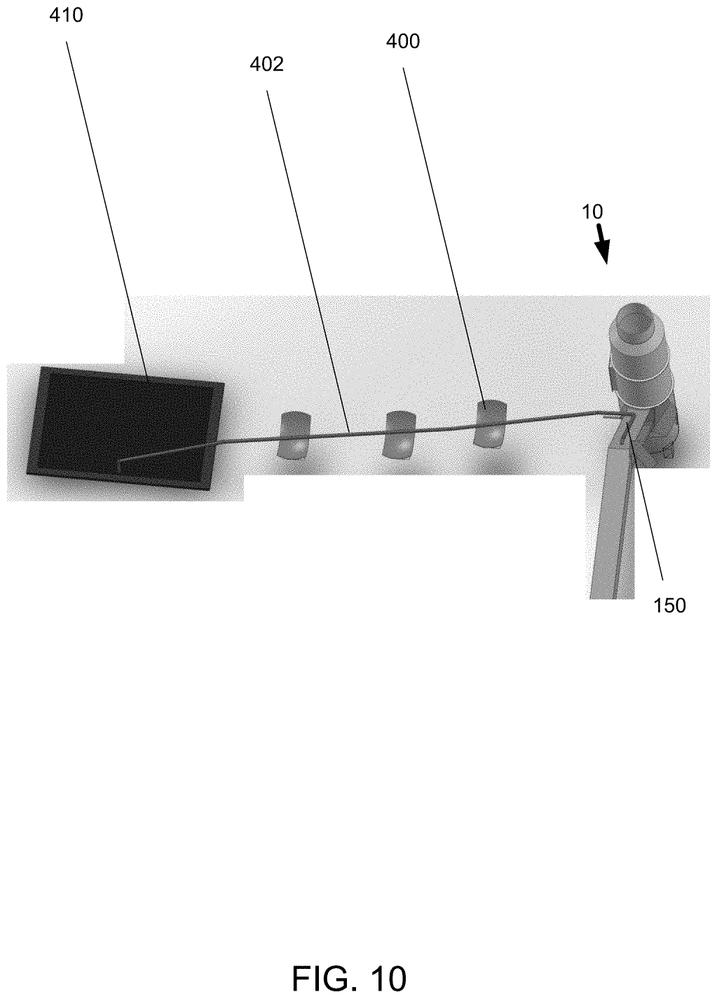

As seen in FIG. 10, the evaporation rate of the produced water in the scrubbing unit 10 can be enhanced or optimized by heating the produced water with one or more parabolic mirrors 400, arranged to capture, concentrate and direct sunlight or other light source to the intake line 412 between the produced water pit 410 and injecting nozzle manifold 150. The concentrated sunlight (or other light source) heats the produced water in transit, so that it enters the turbine exhaust ductwork at an elevated temperature.

The present invention thus provides a more environmentally-friendly and efficient means of addressing several pollution and related concerns. First, the system eliminates open flaring by using turbine exhaust gas and/or the field gas in a field gas flare burner to heat produced water, and scrubbing the emissions using the heated produced water in a scrubbing unit. Second, the system eliminates or reduces the volume of produced water. And third, the system operates at or near the wellhead, thereby allowing use of the field gas while treating the produced water with less energy required.

Thus, it should be understood that the embodiments and examples described herein have been chosen and described in order to best illustrate the principles of the invention and its practical applications to thereby enable one of ordinary skill in the art to best utilize the invention in various embodiments and with various modifications as are suited for particular uses contemplated. Even though specific embodiments of this invention have been described, they are not to be taken as exhaustive. There are several variations that will be apparent to those skilled in the art.

What is claimed is:

1. A system for treating produced water, comprising:
a scrubber unit with a plurality of spray nozzles, said scrubber unit adapted to hold produced water;
means for directing exhaust from a gas turbine to the scrubber unit to heat the produced water in at least a portion of the scrubber unit; and
a produced water pump adapted to circulate produced water from the heated portion to the spray nozzles, whereby sprayed produced water acts as the scrubbing agent in the scrubber unit.

2. The system of claim 1, whereby produced water is evaporated during processing in the scrubber unit.

3. The system of claim 2, further comprising means for removing salts and solids remaining after evaporation of the produced water.

4. The system of claim 3, wherein said means for removing comprises an augur.

5. The system of claim 3, further comprising a treatment mixer.

6. The system of claim 5, wherein the treatment mixer is configured to chemically stabilize the salts and solids removed from the scrubbing unit.

7. The system of claim 1, wherein the means for directing exhaust gas comprises ductwork configured to be connected or attached to a gas turbine.

8. The system of claim 7, further comprising an injecting nozzle manifold configured to introduce produced water.

9. A method for treating produced water, comprising:
introducing produced water into a scrubber unit with a plurality of spray nozzles;
heating, using turbine exhaust gas, the produced water in at least a portion of the scrubber unit;
circulating produced water from the heated portion to the spray nozzles; and
spraying produced water from the spray nozzles, whereby sprayed produced water acts as the scrubbing agent in the scrubber unit.

10. The method of claim 9, further comprising the step of evaporating produced water during processing in the scrubber unit.

11. The method of claim 9, further comprising the step of removing salts and solids remaining after evaporation of the produced water.

12. The method of claim 11, wherein the step of removing comprises removing using an augur.

13. The method of claim 12, further comprising the step of stabilizing the salts and solids removed from the scrubbing unit.
